(19) United States
(12) Patent Application Publication
(10) Pub. No.: US 2025/0175051 A1
(43) Pub. Date: May 29, 2025

(54) METHOD FOR MANUFACTURING MAGNETIC WEDGE, MAGNETIC WEDGE, STATOR FOR ROTATING ELECTRIC MACHINE, AND ROTATING ELECTRIC MACHINE

(71) Applicant: Proterial, Ltd., Tokyo (JP)

(72) Inventors: Shin NOGUCHI, Tokyo (JP); Kazunori NISHIMURA, Tokyo (JP); Keiko KIKUCHI, Tokyo (JP); Yuki ISHIKAWA, Tokyo (JP)

(73) Assignee: Proterial, Ltd., Tokyo (JP)

(21) Appl. No.: 18/843,300

(22) PCT Filed: Aug. 9, 2022
(86) PCT No.: PCT/JP2022/030416

§ 371 Date: Sep. 2, 2024

(51) Int. Cl. H02K 3/493; B22F 1/10; B22F 3/02; B22F 3/24; C22C 38/06; C22C 38/18; H01F 1/20; H02K 15/13

(52) U.S. Cl. CPC H02K 3/493; B22F 1/10; B22F 3/02; B22F 3/24; C22C 38/06; C22C 38/18; H01F 1/20; H02K 15/13; B22F 2003/247; B22F 2003/248; B22F 2301/35; B22F 2304/10; B22F 2998/10; B22F 2999/00; C22C 2202/02

(57) ABSTRACT

Provided are: a magnetic wedge having high strength stability against temperature rise, and being compatible even with complex shapes; a stator for a rotating electric machine; a rotating electric machine; and a method for manufacturing the magnetic wedge. The method has: a first step for obtaining a mixture by mixing a binder and powder of Fe-based soft magnetic particles containing an element M that is more likely to be oxidized than Fe; a second step for obtaining a green compact by pressing the mixture; a third step for subjecting the green compact to machining; and a fourth step for heat-treating the green compact, which has been subjected to the third step, to form surface oxide phases of the Fe-based soft magnetic particles that bind the Fe-based soft magnetic particles together between the particles of the Fe-based soft magnetic particles.

### TECHNICAL FIELD

The present invention relates to a magnetic wedge used in a magnetic circuit of a rotating electric machine, a stator and a rotating electric machine using the magnetic wedge, and a method for manufacturing such a magnetic wedge.

### RELATED ART

In a typical radial gap type rotating electric machine, a stator (hereinafter referred to as stator) and a rotor (rotor) are arranged coaxially, and a plurality of teeth with coils wound thereon are arranged at equal intervals in the circumferential direction on the stator around the rotor. Further, magnetic wedges may be provided at the rotor-side tips of the teeth to connect the tips of adjacent teeth. In this case, the magnetic wedge is different from a coil component or the like, and is used without winding a coil around the magnetic wedge itself.

By providing such magnetic wedges, it is possible to magnetically shield the magnetic flux that reaches the coils from the rotor, and it is possible to suppress eddy current loss of the coils. Furthermore, by providing the magnetic wedges, the magnetic flux distribution in the gap between the stator and the rotor (particularly the magnetic flux distribution in the circumferential direction) is made gentle, enabling the rotor to rotate smoothly. By disposing the magnetic wedges in this manner, a highly efficient and high-performance rotating electric machine can be achieved.

In addition, a conventional method for manufacturing a magnetic wedge is known, as disclosed in Patent Document 1, for example, in which a magnetic sheet is obtained by impregnating a glass cloth with a mixture of magnetic iron powder and epoxy resin, a non-magnetic sheet is obtained by impregnating a glass cloth with epoxy resin, and the magnetic sheet and the non-magnetic sheet are laminated in a sandwich shape so that the thickness ratio of magnetic layers to non-magnetic layers is 1:20:1, and then heated and pressed. The magnetic wedge obtained by this method is known to exhibit favorable properties such as high three-point bending strength of 25 kg/mm², magnetic permeability of 13, and volume resistivity of 10³ Ωcm.

Furthermore, a method for manufacturing a magnetic wedge with large relative magnetic permeability is known, as disclosed in Patent Document 2, for example, in which a liquid made by mixing Fe-3 wt % Si alloy powder with room temperature curing type silicone resin is filled into a desired position of a slot opening of a stator core, and the resin is cured. The magnetic wedge obtained by this method is known to have very high relative magnetic permeability of about 35 at most.

### CITATION LIST

### Patent Documents

[Patent Document 1] Japanese Patent Application Laid-Open No. S62-77030
[Patent Document 2] International Publication No. WO2018/008738

### SUMMARY OF INVENTION

### Technical Problem

Since bending stress is applied to the magnetic wedge disposed in the rotating electric machine by the AC magnetic field, it is desirable for the magnetic wedge to have high bending strength. For example, Patent Document 1 discloses a magnetic wedge with three-point bending strength of about 25 kgf/mm², but in order to meet requirements such as high reliability, a further increase in strength has been desired. The magnetic wedge in Patent Document 2 also has problems with reliability, such as bending strength, because the magnetic wedge is simply made by solidifying alloy powder with resin. Furthermore, the rotating electric machine has unavoidable loss and therefore generates heat during use, causing the temperature to rise. In terms of this, the conventional magnetic wedges disclosed in Patent Document 1 and Patent Document 2 are solidified with resin, and therefore suffer from problems of weight loss and strength loss at a high temperature.

Additionally, in terms of function, the magnetic wedge is required to have a shape suitable for fitting with the stator. For example, recesses for fitting the magnetic wedge are formed in the teeth of the stator, and both end sides of the magnetic wedge to be in contact with the teeth are formed in a shape that matches such a recess so as to be fitted into the recess. Therefore, the magnetic wedge is required to be able to realize and maintain the high strength as described above, and also to be able to easily form a complex shape.

Thus, the present invention aims to provide a magnetic wedge that has high strength stability against temperature rise and is compatible even with a complex shape, a stator for a rotating electric machine, a rotating electric machine, and a method for manufacturing such a magnetic wedge.

### Solution to Problem

A method for manufacturing a magnetic wedge according to the present invention is characterized in including: a first step of obtaining a mixture by mixing a binder and powder of Fe-based soft magnetic particles containing an element M that is more easily oxidized than Fe; a second step of obtaining a green compact by pressing the mixture; a third step of performing machining on the green compact; and a fourth step of heat-treating the green compact, which has been subjected to the third step, to form surface oxide phases of the Fe-based soft magnetic particles that bind the Fe-based soft magnetic particles to each other between particles of the Fe-based soft magnetic particles.

Further, in the method for manufacturing the magnetic wedge, the element M is preferably at least one selected from a group consisting of Al, Si, Cr, Zr, and Hf. Further, in the method for manufacturing the magnetic wedge, the Fe-based soft magnetic particles are preferably Fe—Al—Cr-based alloy particles.

Furthermore, in the method for manufacturing the magnetic wedge, it is preferable that the green compact has a prismatic shape obtained by stretching a line-symmetric figure drawn on an arbitrary plane in a normal direction of the plane, and the machining is performed on a pair of surfaces obtained by stretching a pair of sides located symmetrically in the line-symmetric figure in the normal direction.

Further, in the method for manufacturing the magnetic wedge, the machining is preferably performed on the green compact to form non-parallel surfaces and further increase surface roughness.

Further, in the second step or the third step of the method for manufacturing the magnetic wedge, at least a pair of opposing sides of one or both end surfaces of the green compact in a longitudinal direction are preferably rounded.

A magnetic wedge according to the present invention is characterized in including: a plurality of Fe-based soft magnetic particles, in which the plurality of Fe-based soft magnetic particles contain an element M that is more easily oxidized than Fe, and are bound by oxide phases containing the element M, and at least a portion of a surface of the magnetic wedge is a machined surface.

Further, in the magnetic wedge, the element M is preferably at least one selected from a group consisting of Al, Si, Cr, Zr, and Hf. Further, in the magnetic wedge, the Fe-based soft magnetic particles are preferably Fe—Al—Cr-based alloy particles.

Furthermore, it is preferable that the magnetic wedge has a prismatic shape obtained by stretching a line-symmetric figure drawn on an arbitrary plane in a normal direction of the plane, and at least a pair of surfaces obtained by stretching at least a pair of sides located symmetrically in the line-symmetric figure in the normal direction are machined surfaces.

Further, at least a pair of surfaces obtained by stretching at least a pair of sides located symmetrically in the line-symmetric figure in the normal direction are preferably non-parallel. Further, at least a pair of opposing sides of one or both end surfaces in a longitudinal direction are preferably rounded.

A stator for a rotating electric machine according to the present invention is characterized in including: a plurality of teeth; and a plurality of slots formed by the plurality of teeth, in which the magnetic wedge according to any one of the above is fitted between tips of adjacent teeth. Further, in the stator for the rotating electric machine, the magnetic wedge is preferably in contact with the teeth by at least a portion of the machined surface.

Further, a rotating electric machine according to the present invention is characterized in including the stator for the rotating electric machine according to any one of the above; and a rotor disposed inside the stator for the rotating electric machine.

The above-mentioned configurations can be combined as appropriate.

### Effects of Invention

According to the present invention, it is possible to provide a magnetic wedge that has high strength stability against temperature rise and is compatible even with a complex shape, a stator for a rotating electric machine, a rotating electric machine, and a method for manufacturing such a magnetic wedge.

### BRIEF DESCRIPTION OF DRAWINGS

FIG. 1 is a process flow of the method for manufacturing the magnetic wedge according to the first embodiment of the present invention.

FIG. 2 is an example of the green compact or the magnetic wedge according to the first and second embodiments of the present invention.

FIG. 3 shows modified examples of the cross-sectional shape of the green compact according to the first and second embodiments of the present invention.

FIG. 4 is a perspective view showing modified examples of the green compact according to the first and second embodiments of the present invention.

FIG. 5 is an enlarged schematic view of the magnetic wedge according to the first and second embodiments of the present invention.

FIG. 6 is a schematic view of the rotating electric machine according to the third embodiment of the present invention.

FIG. 7 is a schematic view of the rotating electric machine according to another example of the third embodiment of the present invention.

FIG. 8 is a schematic view of the rotating electric machine according to yet another example of the third embodiment of the present invention.

FIG. 9 is a SEM photograph showing the cross-sectional structure of Example 1.

FIG. 10 is a graph showing the DC magnetization curves of Example 1 and Comparative Example.

FIG. 11 is a graph showing the iron loss of Example 1.

FIG. 12 is a model view of the rotating electric machine used in the electromagnetic field analysis.

FIG. 13 is a graph showing the result of electromagnetic field analysis of the rotating electric machine.

FIG. 14 is a graph showing the temperature dependence of three-point bending strength of Example 1 and Comparative Example.

FIG. 15 is a graph showing the heating loss at 220° C. of Example 1 and Comparative Example.

FIG. 16 is a graph showing the heating loss at 290° C. of Example 1 and Comparative Example.

FIG. 17 is a photograph showing the appearance of the green compact sample of Example 3.

### DESCRIPTION OF EMBODIMENTS

Hereinafter, a method for manufacturing a magnetic wedge according to the present invention will be described as the first embodiment, a magnetic wedge as the second embodiment, and a stator for a rotating electric machine and a rotating electric machine using the magnetic wedge as the third embodiment, respectively with reference to the figures. However, the present invention is not limited to these embodiments. In addition, to clearly describe the present invention, the following description and figures have been simplified as appropriate.

### (First Embodiment) <Method for Manufacturing Magnetic Wedge>

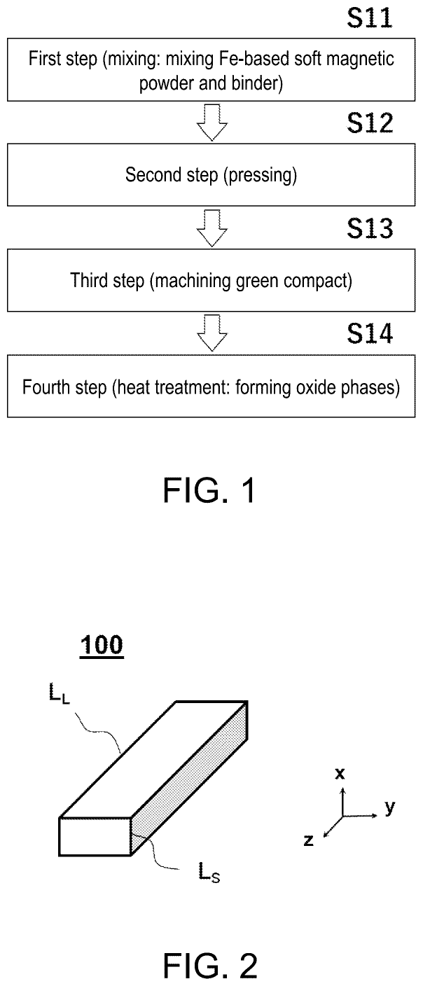

The method for manufacturing a magnetic wedge according to the first embodiment of the present invention will be described with reference to the flow of FIG. 1. This embodiment has a first step S11 of obtaining a mixture by mixing powder of Fe-based soft magnetic particles and a binder, a second step S12 of obtaining a green compact by pressing the obtained mixture, a third step S13 of performing machining on the obtained green compact, and a fourth step S14 of heat-treating the green compact, which has been subjected to the third step S13, to form oxide phases on the surfaces of the Fe-based soft magnetic particles.

In the first step S11, powder of Fe-based soft magnetic particles containing an element M that is more easily oxidized than Fe and a binder are mixed to obtain a mixture. The Fe-based soft magnetic powder refers to soft magnetic alloy powder mainly composed of Fe (the content of Fe is the highest by mass ratio compared to other elements). In addition to Fe, Co and Ni may be contained within a range not exceeding the content of Fe.

The average particle size (median diameter d50 in the volume cumulative distribution) of the Fe-based soft magnetic powder is preferably 1 μm or more and 100 μm or less, and more preferably 5 μm or more and 30 μm or less. By setting such a particle size, the average particle size of the Fe-based soft magnetic particles of the magnetic wedge obtained according to this embodiment can be controlled within a preferred range.

The element M that is more easily oxidized than Fe means an element whose standard Gibbs energy of formation of an oxide is lower than Fe₂O₃. Among the elements that satisfy this condition, one or more types can be selected as the element M from the group consisting of Al, Si, Cr, Zr, and Hf, from the viewpoint of having less excessive reactivity and toxicity and facilitating the manufacture of a magnetic wedge. Among these, the Fe-based soft magnetic particles are preferably Fe—Al—Cr-based alloy particles. By containing such an element M, good surface oxide phases can be formed on the Fe-based soft magnetic particles later. Specifically, oxidizing the Fe-based soft magnetic powder after pressing makes it possible to easily form surface oxide phases having a higher content of the element M than the interior of the Fe-based soft magnetic particles.

Granular powder with good compactivity produced by an atomization method (for example, a gas atomization method or a water atomization method) can be used as the Fe-based soft magnetic powder. In addition, powder produced by a pulverization method can also be used as the flat powder for the purpose of utilizing the shape anisotropy. Alternatively, powder containing particles that have been surface-treated by a chemical method, heat treatment, or the like may be used. For the purpose of adjusting the relative magnetic permeability, non-magnetic powder may be mixed with the Fe-based soft magnetic powder containing the element M that is more easily oxidized than Fe.

The binder is used in the second step S12 described later to temporarily bond the particles together and provide a certain degree of strength to the green compact. In addition, the binder also serves to provide suitable spacing between the particles. As for the type of the binder, for example, an organic binder such as polyvinyl alcohol or acrylic resin can be used. The organic binder is thermally decomposed by heat treatment after pressing.

The binder is preferably added in an amount sufficient to be well distributed throughout the entire mixture, ensure sufficient strength of the green compact, and be thermally decomposed sufficiently in the third step S13 described later. For example, in a case where the second step S12 described later is pressure pressing, it is preferable to add 0.5 parts by mass to 3.0 parts by mass of the binder relative to 100 parts by mass of the Fe-based soft magnetic powder in order to withstand the machining performed in the third step S13 described later.

The method for mixing in the first step S11 can be a known mixing method or use a mixer. The form of mixing can be selected according to the pressing method to be applied. Hereinafter, pressure pressing in which a granulation process is applied will be mainly described as an example.

In order to obtain a mixture (granulated powder) having spherical particles with a uniform particle size, it is preferable to apply a method of spray-drying a slurry-like mixture, which includes Fe-based soft magnetic powder, a binder, and a solvent such as water, using a spray dryer. In addition, a lubricant such as stearic acid or stearate may be added to the mixture to reduce friction between the powder and the die in the second step S12. In this case, the amount added is preferably 0.1 parts by mass to 2.0 parts by mass relative to 100 parts by mass of the mixed powder (granulated powder). Nevertheless, the lubricant may not be added to the mixture in the first step S11, but may be applied to the die in the second step S12. Spray drying can produce granulated powder with a sharp particle size distribution and a small average particle size. In order to obtain a sharper particle size distribution, the granulated powder may pass through a sieve, for example, using a vibrating sieve, to obtain granulated powder having a desired secondary particle size, which may then be applied to the second step S12. From the viewpoint of increasing powder feedability (powder fluidity) during pressing, the average particle size (median diameter d50) of the granulated powder is preferably 40 μm to 150 μm, and more preferably 60 μm to 100 μm.

In the second step S12, the mixture obtained in the first step S11 is pressed to obtain a green compact. Various known methods (for example, sheet pressing, pressure pressing, extrusion pressing, or the like) can be applied as the pressing method. For example, in a case where sheet pressing is applied, green sheets manufactured to a certain thickness by a pressing machine such as a doctor blade can be laminated and crimped to obtain a green compact having a predetermined thickness. In a case where pressure pressing is applied, the mixture obtained in the first step can be filled into a pressing die and pressed with a press machine to form a predetermined shape such as a columnar shape or a rectangular parallelepiped shape. In this case, the pressing may be performed at room temperature, or warm pressing may be performed by heating the mixture to a degree that does not cause the binder to disappear.

As described above, there are several possible pressing methods, but pressure pressing using a press machine and a pressing die is preferred. Furthermore, since the dimensions, shape, surface roughness, etc. are adjusted by machining in the third step S13 described later, it is not necessary to obtain a green compact of a near net shape or a final shape in the second step S12.

The space factor of the obtained green compact can be adjusted to a desired range by adjusting the pressing conditions such as the pressing pressure and temperature during pressure pressing. In the third step S13 described later, in order to prevent chipping during machining and to improve dimensional accuracy, it is effective to increase the space factor of the green compact. On the other hand, an excessively high space factor is not preferable for it leads to poor mass productivity. Therefore, the space factor of the green compact to be subjected to the third step is preferably 78% to 90%, more preferably 79% to 88%, and even more preferably 81% to 86%.

Furthermore, by using Fe—Cr—Al-based Fe-based soft magnetic powder having excellent compactivity, it is also possible to increase the space factor of the green compact to be subjected to the third step S13 to 82% or more even at a low pressing pressure. In the second step S12, the space factor of the green compact can be adjusted to such a range by adjusting the pressing pressure, etc. The space factor (relative density) of the green compact to be subjected to the third step S13 is calculated by dividing the density of the green compact by the true density of the Fe-based soft magnetic powder. In this case, the mass of the binder and lubricant contained in the green compact is subtracted from the mass of the green compact based on the amount added. Moreover, the true density of the Fe-based soft magnetic powder may be the density of an ingot produced by melting the powder with the same composition.

In the third step S13, machining is performed on the green compact obtained in the second step S12 described above to have a desired shape, dimensions, and surface roughness. The machining in the third step means any one of machining methods such as cutting, cutting off, and grinding, or a combination of several of these machining methods. Grinding can be performed using a rotating grindstone or the like, cutting can be performed using a cutting tool or the like, and cutting off can be performed using a cutting blade or the like. Furthermore, the term is not limited to the surface state as it is after machining, but also includes a surface whose properties have been changed by heat treatment, coating treatment, etc. after machining. The surface that has been subjected to such machining is called a machined surface. The machined surface is more preferably a surface that has been subjected to heat treatment to form a surface oxide phase. Since the strength of the magnetic wedge becomes very high after the heat treatment in the fourth step described later, the series of manufacturing steps can be simplified by completing the machining before that.

Here, the rectangular parallelepiped shown in FIG. 2 will be described as an example of the shape of the green compact. FIG. 2 shows a state in which the surface (end surface) of the green compact with the smallest surface area is placed on the xy plane, and the surface (plane surface) of the green compact with the largest surface area is placed on the yz plane when the left-right direction of the paper is defined as the y direction, the up-down direction of the paper is defined as the x direction, and the depth direction of the paper is defined as the z direction. A surface parallel to the xz plane at this time is called a side surface. Moreover, a cross section of the green compact cut along a surface parallel to the xy plane is simply called a cross section.

That is, the green compact shown in FIG. 2 can be said to have a prismatic shape obtained by stretching a rectangular cross section on the xy plane in the z direction. In other words, the green compact can be said to have a prismatic shape obtained by stretching a line-symmetric figure drawn on an arbitrary plane in the normal direction of the plane. At this time, the end surface can be said to be a surface parallel to the figure drawn on an arbitrary plane. In addition, the plane surface and the side surface can be said to be a pair of surfaces obtained by stretching a pair of sides located symmetrically in the figure drawn on an arbitrary plane in the normal direction.

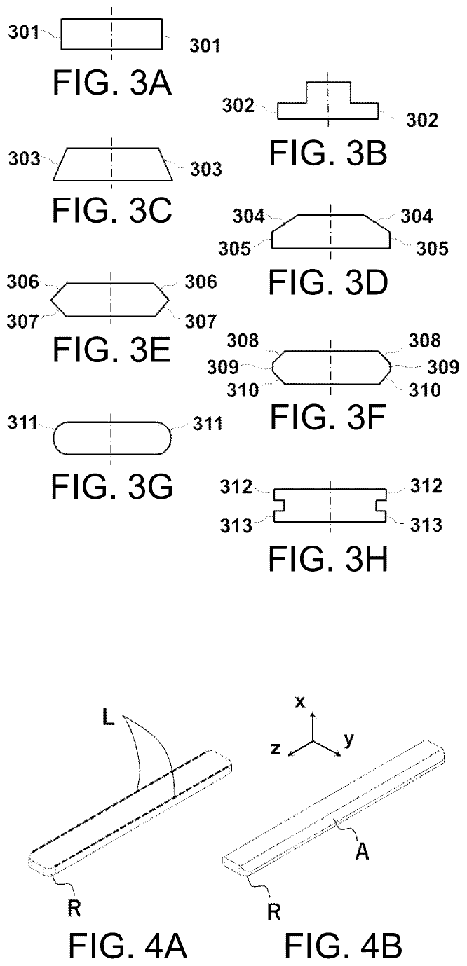

Furthermore, the side shared by the plane surface and the side surface is called a side L_{L} in the length direction, and the side shared by the side surface and the end surface is called a side L_{S} in the thickness direction. FIG. 3 shows modified examples of the cross-sectional shape of the green compact.

These cross sections are line-symmetric figures. The line-symmetric figures include, for example, rectangles, isosceles trapezoids, and line-symmetric polygons, as well as other stepped shapes and figures with circular arcs in part.

Further description will be given with reference to FIG. 3. (a) is an example in which the cross section is rectangular. Reference numeral 301 denotes a pair of opposing side surfaces. (b) to (h) are shapes obtained by machining the side surfaces 301. (b) is a modified example having a T-shaped cross section, with a pair of side surfaces 302 being parallel to each other. (c) is a modified example in which the cross section is trapezoidal, and a pair of side surfaces 303 are non-parallel. Furthermore, (d) is a combination of (a) and (c), and has non-parallel side surfaces 304 and parallel side surfaces 305 on a pair of side surfaces on both end sides. Further, (e) is a modified example that has two non-parallel side surfaces 306 and 307 on a pair of side surfaces on both end sides, and both end portions form acute-angled triangular shapes. In addition, (f) is a modified example obtained by providing parallel side surfaces on a part of both side surfaces of (e), and has two non-parallel side surfaces 308 and 310 on a pair of both side surfaces and further has parallel side surfaces 309. Further, (g) is a modified example in which both side surfaces are formed by curved surfaces 311. Moreover, (h) is a modified example in which a pair of parallel side surfaces are divided into parallel side surfaces 312 and 313 by providing a recess in each of the parallel side surfaces.

Machining may be performed, for example, on at least one plane surface of the surfaces of the prismatic green compact. Further, for a prismatic green compact having a line-symmetric cross section, a pair of side surfaces that are located symmetrically when viewed from the axial direction (longitudinal direction) can also be formed by machining. For example, machining may be performed on a pair of opposing plane surfaces of a rectangular parallelepiped green compact. Furthermore, machining may be performed on a pair of opposing plane surfaces of a rectangular parallelepiped green compact obliquely, that is, by rounding off the corners (ridges) of the rectangular parallelepiped, so that a pair of side surfaces become non-parallel. By performing such machining, a magnetic wedge having a trapezoidal cross section can be easily produced. This means that a non-parallel surface with relatively large surface roughness can be used as a fitting surface (contact surface) for fitting to the teeth. The direction of machining such as grinding and cutting is preferably the longitudinal direction of the prismatic green compact for it is easy to achieve flatness.

In a case where pressing is performed using a die, the surface roughness of the green compact directly reflects the surface roughness of the die, resulting in a very smooth surface. However, when using the green compact as a magnetic wedge and fitting the magnetic wedge to the teeth of a stator for a rotating electric machine, it is preferable for the surface roughness to be rough in order to exert a strong fixing effect. Further, when forming a coating on the surface of the magnetic wedge or later applying an adhesive, a rough surface can be expected to improve adhesion strength due to the anchor effect. Therefore, it is preferable that the contact surface when fitting and the surface when applying the coating or adhesive layer are not the surfaces when removed from the die, but are made rough by machining (with fine unevenness).

By performing machining on the green compact, a desired shape can be obtained, and the surface roughness can be increased compared to the surface obtained after pressing using a die. At this time, the entire surface of the green compact may be machined, but since such machining requires unnecessary man-hours and becomes complicated, it is preferable to machine only the necessary portions. After the heat treatment in the fourth step described later, the strength of the green compact becomes very high and makes it difficult to perform machining, so it is preferable to carry out machining before the heat treatment.

By performing machining, the ratio R_{MD}/R_{AS} of the average R_{MD} of the arithmetic mean roughness Ra of the machined surface to the average R_{AS} of the arithmetic mean roughness Ra of the non-machined surface can be set to about 2 to 5. This value is a measurement value after going through the fourth step S14 described later. The arithmetic mean roughness is determined by evaluating roughness at a plurality of locations with an area of 1.0 mm² or more per location using a laser microscope, and the average value is used as the arithmetic mean roughness.

The plane surface (yz surface) of the green compact shown in FIG. 2 is rectangular, but the corners of this rectangle (side L_{S} in the thickness direction) may be rounded. That is, in the prismatic magnetic wedge, at least a pair of opposing sides of one or both end surfaces in the longitudinal direction (z direction) may be rounded.

FIG. 4 is a perspective view of a case where a green compact has corners (side L_{S} in the thickness direction) with roundness R. (a) is an example of a case where the cross section is rectangular (the shape of (a) of FIG. 3), and (b) is an example of a case where non-parallel side surfaces A are obtained by machining a pair of opposing sides L_{L} in the longitudinal direction (that is, turning the cross section into a modified trapezoidal shape) (the shape of (d) of FIG. 3). Such a shape has the effect of making it easy to insert the magnetic wedge to the tip portions of the teeth in the third embodiment which will be described later.

Moreover, the effect of the roundness can be obtained regardless of the compositions of the powder of the Fe-based soft magnetic particles and the binder. That is, the manufacturing method of this embodiment has a first step of obtaining a mixture by mixing powder of soft magnetic particles and a binder, a second step of obtaining a green compact by pressing the mixture, a third step of performing machining on the green compact, and a fourth step of heat-treating the green compact that has been subjected to the third step. Here, it is preferable that the green compact has a prismatic shape obtained by stretching a line-symmetric figure drawn on an arbitrary plane in the normal direction of the plane, at least a pair of surfaces obtained by stretching at least a pair of sides located symmetrically in the line-symmetric figure in the normal direction are machined surfaces, and in the second step or the third step, at least a pair of opposing sides of one or both end surfaces of the green compact in the longitudinal direction are rounded.

Furthermore, the effect of the roundness is more easily achieved as the roundness becomes larger, but if the roundness is too large, a large gap is created between the magnetic wedge and the tip portion of the tooth in this portion. This not only weakens the force that fixes the magnetic wedge but also disrupts the distribution of magnetic flux around the gap, so the effect of the magnetic wedge in improving motor efficiency is impaired.

From this viewpoint, the size (radius) of the roundness is preferably less than ½ of the width (length in the y direction) of the magnetic wedge, more preferably ⅓ or less, and even more preferably ¼ or less. On the other hand, if the roundness is too small, it becomes difficult to achieve the above-mentioned effect, so the size (radius) of the roundness is preferably 1/20 or more of the width (length in the y direction) of the magnetic wedge, more preferably 1/10 or more, and even more preferably ⅕ or more. The shape of the roundness is not limited to a circular arc but may be an elliptical arc or other curves, and it is even better if the shape is pointed in the longitudinal direction (z direction). Such a shape allows the magnetic wedge to be easily inserted to the tip portions of the teeth.

Since the effect of facilitating the insertion of the magnetic wedge to the tip portions of the teeth is an effect that comes from the shape, the effect can be enjoyed regardless of the material of the magnetic wedge or whether the magnetic wedge has a machined surface. That is, the above-mentioned effect can be achieved with a prismatic magnetic wedge which is formed by bonding a plurality of Fe-based soft magnetic particles and in which at least a pair of opposing sides of one or both end surfaces in the longitudinal direction are rounded.

In addition, since the roundness is provided intentionally, the radius of the roundness is preferably made larger than any roundness that may exist on a surface other than both end surfaces of the magnetic wedge in the longitudinal direction, for example.

This roundness (or any curved portion) may be formed when machining the side surface in the third step S13, or the shape may be formed in the second step S12 described above by pressing using a die having a rounded shape (or any curved portion) at the corners. In terms of manufacturing, if possible, it is preferable to manufacture a green compact with rounded portions during pressing, which involves fewer machining steps and is advantageous for improving productivity and reducing costs.

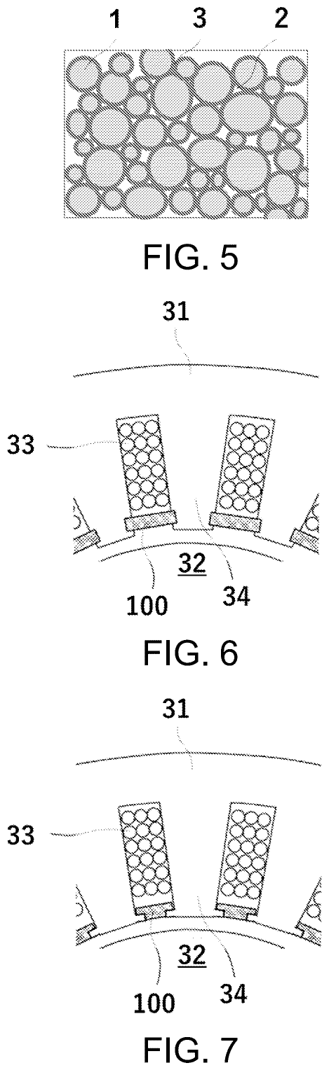

In the fourth step S14, the green compact obtained through the third step S13 is heat-treated to form a compacted body (magnetic wedge). FIG. 5 shows an enlarged schematic view of a cross section of the magnetic wedge. During the heat treatment, the binder present between the particles of the Fe-based soft magnetic particles 1 in the green compact is thermally decomposed and disappears, which forms voids 2 between the particles. By further continuing the heat treatment, the Fe-based soft magnetic particles 1 are oxidized, and surface oxide phases 3 of the Fe-based soft magnetic particles 1 that bond the Fe-based soft magnetic particles 1 to each other are formed between the particles of the Fe-based soft magnetic particles 1. The surface oxide phase 3 is formed between particles (at grain boundaries), and therefore may be called a grain boundary oxide phase.

Such oxide phases constitute the grain boundary phases between the Fe-based soft magnetic particles, and improve the insulating properties and corrosion resistance of the Fe-based soft magnetic particles. Further, since such oxide phases are formed after the formation of a green compact (bulk body) rather than in a powder state, the oxide phases also contribute to the bonding between the Fe-based soft magnetic particles, resulting in a compacted body (magnetic wedge) with significantly higher strength than the green compact state. The voids 2 are formed in the portions that cannot be filled with such surface oxide phases between the Fe-based soft magnetic particles 1.

For example, in a case where Fe—Cr-M′-based (M′ is at least one of Al and Si) powder is used as the Fe-based soft magnetic powder, the following structure is obtained. In a case where M′ is Si, that is, in a case where Al is not actively added, Cr is particularly concentrated in the oxide phase, and oxide phases having a higher ratio of Cr to the sum of Fe, Cr, and M′ (Si) than the internal alloy phases are formed on the surfaces of the Fe-based soft magnetic particles. On the other hand, in a case where Al is contained as M′, Al is particularly concentrated in the oxide phase, and oxide phases having a higher ratio of Al to the sum of Fe, Cr, and M′ than the internal alloy phases are formed on the surfaces of the Fe-based soft magnetic particles.

The heat treatment can be performed in an atmosphere in which oxygen is present, such as in air or in a mixed gas of oxygen and an inert gas. Alternatively, the heat treatment can be performed in an atmosphere in which water vapor is present, such as in a mixed gas of water vapor and an inert gas. Among these, heat treatment in air is simple and is preferred. The pressure of the heat treatment atmosphere is not particularly limited, but atmospheric pressure which does not require pressure control is preferred.

The heat treatment may be performed by heating to a temperature that enables the surface oxide phases 3 for bonding the Fe-based soft magnetic particles 1 to each other to be formed between the particles of the Fe-based soft magnetic particles. However, if the heat treatment temperature is low, there is a possibility that the distortion applied to the green compact during pressing may not be alleviated and may remain, whereas if the heat treatment temperature is high, there is a possibility that the Fe-based soft magnetic particles may sinter together, resulting in a magnetic wedge with reduced electrical resistance and large eddy current loss. Therefore, the heat treatment temperature is preferably in a range of 600° C. to 900° C., and more preferably in a range of 700° C. to 800° C. The retention time is not particularly limited, and is set appropriately depending on the size of the magnetic wedge, the amount of processing, etc. The retention time is preferably, for example, 0.5 hours to 3 hours.

Since machining is performed in the third step as described above, the alloy phases inside the Fe-based soft magnetic particles are exposed at the machined surface. In contrast thereto, through the heat treatment in the fourth step, the exposed portions of the alloy phases are covered with oxide phases, so the insulating properties of the machined surface are ensured. The heat treatment in the fourth step serves to remove the distortion during pressing, bond the Fe-based soft magnetic particles to each other, and form an insulating layer on the machined surface, so that it is possible to efficiently manufacture a highly insulating magnetic wedge with high strength.

Other steps may be added before or after each of the first to fourth steps. Specifically, a step of forming an insulating coating may be added before the first step, a preheating step may be provided between the second step and the third step, an additional machining step may be provided after the fourth step to remove burrs, and further, a step of forming an electrically insulating coating may be added after the fourth step regardless of whether burrs are removed or not. These steps will be described below.

Before the first step, a preliminary step of forming an insulating coating on the Fe-based soft magnetic powder by heat treatment, a sol-gel method, or the like may be added. However, in the method for manufacturing a magnetic wedge according to this embodiment, the oxide phases can be formed on the surfaces of the Fe-based soft magnetic particles by the fourth step, so it is more preferable to omit such a preliminary step and simplify the manufacturing steps.

A preheating step may be provided between the second step and the third step. For example, in a case of manufacturing a magnetic wedge of a complex shape or a magnetic wedge having a thin portion, if there is concern about damage to the magnetic wedge in the third step, it is preferable to increase the strength of the green compact to be subjected to the third step to be higher than in the as-pressed state. Specifically, it is preferable to have a preheating step between the second step and the third step, in which the green compact is heated to a temperature lower than the heat treatment temperature in the fourth step. The heat treatment in the fourth step forms oxide phases containing the elements contained in the Fe-based soft magnetic particles on the surfaces of the Fe-based soft magnetic particles, and significantly increases the strength of the obtained magnetic wedge, but it is also possible to increase the strength of the green compact by heating to a temperature lower than the temperature of the heat treatment.

From the viewpoint of effectiveness of heating, the heating temperature in the preheating step is set to be higher than room temperature, but if the heating temperature is too high, the machining in the third step becomes difficult. Therefore, in a case where the above-mentioned preheating is performed, the preheating is performed at a temperature lower than the heat treatment temperature in the fourth step. In a case of, for example, Fe—Cr-M′-based (M′ is at least one of Al and Si) powder, the heating temperature is preferably equal to or lower than the temperature at which Al and Cr other than Fe among the elements contained in the Fe-based soft magnetic powder are oxidized and concentrated at the grain boundaries, and is more preferably 300° C. or lower. A heating temperature of 300° C. or lower is also preferable in that the heating temperature can be applied not only to Fe—Cr-M′-based Fe-based soft magnetic powder but also to other soft magnetic material powder. Furthermore, in order to enhance the effect of improving strength by heating, the heating temperature is preferably 100° C. or higher.

If the retention time of heating is too short, the effect of increasing the strength of the green compact decreases, whereas if the retention time is longer than necessary, the productivity decreases, so the retention time is preferably, for example, 10 minutes or more and 4 hours or less. More preferably, the retention time is 30 minutes or more and 3 hours or less. The atmosphere during preheating is not limited to an oxidizing atmosphere. The atmosphere is preferably air for simplifying the steps. Through the above-mentioned preheating step, the bending strength of the green compact to be subjected to the third step can exceed 15 MPa.

After the fourth step, an additional machining step may be provided to remove burrs. In a case where the magnetic wedge obtained through the fourth step has burrs, dimension adjustment may be required. In this case, it is possible to add a fifth step of further performing machining on the magnetic wedge obtained through the fourth step to remove burrs. Furthermore, a sixth step can be added to heat-treat the magnetic wedge obtained through the fifth step, and this heat treatment can also form oxide phases containing elements contained in the Fe-based soft magnetic particles on the additionally machined surface.

Regardless of whether burrs are removed or not, a new step can be added after the fourth step, in which the compacted body obtained in the fourth step is used as a base material and an electrically insulating coating is formed on the surface thereof. In this way, the electrical resistance and strength of the magnetic wedge can be further increased, and particles can be prevented from falling off from the surface of the compacted body, thereby providing a highly reliable magnetic wedge. For the coating, an electrically insulating coating made of resin, oxide, or the like is preferred in order to suppress eddy current loss. For example, a powder coating with epoxy resin, a sealing coating by impregnation with a varnish or silicone resin, a sealing coating of an inorganic material by a sol-gel method using metal alkoxide, and the like can be used. Among these, from the viewpoint of avoiding deterioration of the resin at high temperature, a sealing coating of an inorganic material by a sol-gel method, which contains no resin, is particularly preferred.

### (Second Embodiment) <Magnetic Wedge>

The magnetic wedge of this embodiment has a plurality of Fe-based soft magnetic particles, which contain an element M that is more easily oxidized than Fe and are bound by oxide phases containing the element M, and at least a portion of the surface is a machined surface. The shape of the magnetic wedge varies depending on the manner of connection with the teeth, the longitudinal ridge may have a step, a taper, or a notch, and the cross section may have a polygonal shape such as a trapezoid, or an irregular shape.

Reference numeral 100 shown in FIG. 2 is described as a green compact in the first embodiment above, but can be read as a magnetic wedge in this embodiment. The approximate dimensions of the magnetic wedge are, for example, about 10 mm to 300 mm in the longitudinal direction (z direction), 2 mm to 20 mm in the width direction (y direction), and 1 mm to 5 mm in the thickness direction (x direction).

FIG. 5 is an enlarged schematic view of a cross section of the magnetic wedge of this embodiment. The magnetic wedge is composed of a plurality of Fe-based soft magnetic particles, and is more specifically a compacted body of a plurality of Fe-based soft magnetic particles 1 containing the element M that is more easily oxidized than Fe. Further, the compacted body has voids 2 between the particles, and surface oxide phases 3 of the Fe-based soft magnetic particles that bind the Fe-based soft magnetic particles 1 to each other. Such surface oxide phases 3 are oxide phases containing the element M.

By containing such an element M, good surface oxide phases 3 that firmly bond the Fe-based soft magnetic particles 1 to each other can be easily formed. Specifically, by oxidizing a plurality of Fe-based soft magnetic particles 1 after pressing, it is possible to easily form the surface oxide phases 3 that have a higher content of the element M than the inside of the Fe-based soft magnetic particles 1. In particular, in a case of selecting Al as the element M, particularly good surface oxide phases 3 can be obtained, which is preferred.

The surface oxide phase 3 is chemically stable and has high electrical resistance, and adheres strongly to the Fe-based soft magnetic particles 1 to form a strong surface oxide phase. The surfaces of the Fe-based soft magnetic particles are covered with the surface oxide phases formed in a layer shape. That is, such surface oxide phases isolate the particles of the Fe-based soft magnetic particles 1 from each other, thereby providing a magnetic wedge with high electrical resistance. Furthermore, the surface oxide phases firmly bond the Fe-based soft magnetic particles 1 to each other, thereby providing a magnetic wedge with high bending strength.

If the amount of the element M contained in the Fe-based soft magnetic particles 1 is too small, even with the Fe-based soft magnetic particles 1 oxidized, it is difficult to form good surface oxide phases having a higher content of the element M than the inside of the Fe-based soft magnetic particles. If the amount is too large, the Fe concentration may be diluted, so the saturation magnetic flux density and Curie temperature of the Fe-based soft magnetic particles may decrease. Therefore, the amount of the element M contained in the Fe-based soft magnetic particles is preferably 1.0% by mass or more and 20% by mass or less. In this way, good surface oxide phases 3 can be easily formed, and the saturation magnetic flux density and Curie temperature of the Fe-based soft magnetic particles 1 can be maintained high. That is, a magnetic wedge having high electrical resistance, bending strength, and high magnetic shielding properties can be realized.

Furthermore, the element M is not limited to one type, and may be selected from two or more types, such as combinations of Al and Cr, Si and Cr, etc., including at least Cr as the element M. It is more preferable to select two types, Al and Cr, and the Fe-based soft magnetic particles are Fe—Al—Cr-based alloy particles. In this way, even with a relatively small amount of Al, good surface oxide phases that have a higher total content of the element M than the inside of the Fe-based soft magnetic particles can be formed. That is, a magnetic wedge having high bending strength and adjusted relative magnetic permeability can be obtained.

An Fe—Al—Cr-based alloy refers to an alloy in which Cr and Al (in no particular order) are the next most abundant elements after Fe, and other elements may be contained in smaller amounts than Fe, Cr, and Al. The composition of the Fe—Al—Cr-based alloy is not particularly limited, but for example, the content of Al is preferably 2.0% by mass or more, and more preferably 5.0% by mass or more. From the viewpoint of obtaining high saturation magnetic flux density, the content of Al is preferably 10.0% by mass or less, and more preferably 6.0% by mass or less. In addition, the content of Cr is preferably 1.0% by mass or more, and more preferably 2.5% by mass or more. From the viewpoint of obtaining high saturation magnetic flux density, the content of Cr is preferably 9.0% by mass or less, and more preferably 4.5% by mass or less.

In a case where two or more elements are selected as the element M, the total content of these is preferably 1.0% by mass or more and 20% by mass or less, similarly to the case where one element is selected.

The Fe-based soft magnetic particles may be particles added with elements other than the element M. However, it is preferable to add these additional elements in smaller amounts than the element M. The Fe-based soft magnetic particles can also be composed of a plurality of types of Fe-based soft magnetic particles having different compositions.

The surface oxide phase may contain Fe or other elements in addition to the element M, and the element concentrations of the element M, Fe, etc. are not necessarily uniform inside the surface oxide phase. That is, the element concentration may differ for each grain boundary.

As the thickness of the surface oxide phase increases, the electrical isolation between the particles becomes greater, and the resistivity of the magnetic wedge increases. On the other hand, the surface oxide phase is preferably thin in order to improve the relative magnetic permeability and the magnetic shielding effect. From the viewpoint of providing a magnetic wedge with high resistivity and bending strength and adjusted relative magnetic permeability, the thickness of the surface oxide phase is preferably, for example, 0.01 μm to 1.0 μm.

Reducing the particle size of the Fe-based soft magnetic particles is advantageous for reducing eddy current loss that occurs in the magnetic wedge itself, but if the particle size is too small, it may become difficult to manufacture the particles themselves. Therefore, in a cross-sectional observation image of the magnetic wedge, the average maximum diameter of each particle of the Fe-based soft magnetic particles is preferably 0.5 μm or more and 15 μm or less, and more preferably 0.5 μm or more and 8 μm or less. Further, the ratio of the number of particles having the maximum diameter exceeding 40 μm is preferably less than 1.0%. The average maximum diameter of each particle of the Fe-based soft magnetic particles referred to here is the average value of the maximum diameters of 30 particles or more present within a certain area of visual field, which are obtained by polishing the cross section of the magnetic wedge and observing the cross section under a microscope.

As the voids and the surface oxide phases exist between the particles of the Fe-based soft magnetic particles, the average particle spacing between the Fe-based soft magnetic particles can be widened to increase the electrical resistance of the magnetic wedge. In addition, the relative magnetic permeability of the magnetic wedge can also be adjusted by adjusting the volume ratio of the voids and the surface oxide phases to the entire magnetic wedge. In other words, the volume ratio of the voids and the surface oxide phases to the entire magnetic wedge and the volume ratio of the Fe-based soft magnetic particles (hereinafter referred to as the space factor) are in a complementary relationship, so the relative magnetic permeability of the magnetic wedge can also be adjusted by adjusting the space factor of the Fe-based soft magnetic particles.

The space factor is defined as the ratio (relative density) of the density of the magnetic wedge to the true density of the Fe-based soft magnetic particles. The space factor can be adjusted by the pressing pressure of the mixture or the heat treatment temperature of the green compact, as will be described in the following embodiments.

The relative magnetic permeability mentioned here is the value u obtained by dividing the magnetic flux density value (unit: T) at an applied magnetic field of 160 kA/m in the DC B—H curve of the magnetic wedge by the magnetic field value (that is, 160 kA/m), and then dividing this value by the magnetic permeability of a vacuum (4π×10⁻⁷ H/m). Further, the relative magnetic permeability may be the value μi obtained by dividing the slope of a magnetization curve (so-called minor loop) measured at an excitation level of 1/10 or less of the saturation magnetic flux density of the magnetic wedge and at a frequency (including direct current) of 1/10 or less of the natural resonance frequency of the magnetic wedge by the magnetic permeability of a vacuum (4π×10⁻⁷ H/m). The natural resonance frequency refers to the frequency at which the imaginary part of the relative magnetic permeability becomes maximum, and when multiple maxima appear, the frequency at the lowest frequency side is adopted.

As the relative magnetic permeability of the magnetic wedge increases, the magnetic shielding effect becomes greater, and the loss is reduced. On the other hand, if the relative magnetic permeability is too high, the magnetic flux does not flow from the teeth to the rotor and short-circuits between the teeth, resulting in a decrease in the torque of the rotating electric machine. Such an effect also depends on the thickness of the magnetic wedge. By making the magnetic wedge thinner, it is possible to adjust the magnetic resistance even if the magnetic wedge has high relative magnetic permeability, thereby achieving both loss reduction and torque to a certain extent. Moreover, if the magnetic wedge is too thick, it may undesirably take up too much space for installing the coil. Since the magnetic wedge of this embodiment has high strength, it is particularly suitable to make the magnetic wedge thin. Therefore, the thickness of the magnetic wedge can be set to, for example, 3 mm or less.

When the thickness of the magnetic wedge is 3 mm or less, in order to maintain the loss reduction effect of the magnetic shield, the relative magnetic permeability u of the magnetic wedge is preferably 4 or more (μi of 5 or more), and more preferably 7 or more (μi of 10 or more). Therefore, the space factor of the Fe-based soft magnetic particles in the magnetic wedge is preferably 50% or more, and more preferably 70% or more.

On the other hand, if the magnetic wedge is made too thin, the load resistance may decrease, causing the strength to become insufficient. From this viewpoint, the thickness of the magnetic wedge is preferably 0.5 mm or more, and more preferably 1 mm or more. When the thickness of the magnetic wedge is 1 mm or more, in order to suppress a decrease in the torque of the rotating electric machine, the relative magnetic permeability μ of the magnetic wedge is preferably adjusted to 8.0 or less (μi of 65 or less), more preferably to 7.5 or less (μi of 50 or less), and even more preferably to 7.0 or less (μi of 35 or less). Therefore, the space factor of the Fe-based soft magnetic particles in the magnetic wedge is preferably less than 90%, and more preferably 85% or less.

The magnetic wedge preferably has high relative magnetic permeability in order to provide good magnetic shielding for the coil, and preferably has high electrical resistance in order to suppress eddy current loss due to the AC magnetic field of the coil and the rotor. The volume resistivity of the magnetic wedge is preferably 10 Ω·m or more, more preferably 20 Ω·m or more, and even more preferably 100 Ω·m or more. Further, the volume resistivity of the magnetic wedge is even more preferably 1000 Ω·m or more. The bending strength of the magnetic wedge is also preferably as high as possible, and the value of three-point bending strength is preferably 150 MPa or more, and more preferably 200 MPa or more. Further, the three-point bending strength of the magnetic wedge is even more preferably 250 MPa or more.

The form having the Fe-based soft magnetic particles and the surface oxide phases described above makes it possible to realize a magnetic wedge with high electrical resistance and bending strength. With such a form and the voids 2, it is possible to provide a magnetic wedge with high electrical resistance and bending strength, and adjusted relative magnetic permeability. For the purpose of adjusting the relative magnetic permeability, a compacted body of a

plurality of Fe-based soft magnetic particles containing an element M that is more easily oxidized than Fe, and a plurality of non-magnetic particles can also be used. In such a case, the Fe-based soft magnetic particles are also bound to each other by oxide phases containing the element M. The term “non-magnetic” mentioned here means that the particles are not ferromagnetic at room temperature. Specifically, the term means particles that exhibit any one of paramagnetic, diamagnetic, and antiferromagnetic properties at room temperature. Additionally, the non-magnetic particles may be metallic or non-metallic such as oxide. The non-magnetic particles, when present between the Fe-based soft magnetic particles, can widen the average particle spacing between the Fe-based soft magnetic particles, thereby lowering the relative magnetic permeability of the magnetic wedge due to the demagnetizing field effect. That is to say, it is possible to adjust the relative magnetic permeability by adjusting the content of the non-magnetic particles.

Since the conventional magnetic wedge is manufactured by dispersing iron powder in epoxy resin and binding soft magnetic particles together with epoxy resin, the resin component decreases as the temperature rises, and in a high-temperature environment, the resin may soften and reduce the binding strength. That is, when the magnetic wedge is used under a high temperature such as in a rotating electric machine, there is a possibility that problems may arise with the bending strength. In contrast thereto, the magnetic wedge of this embodiment bonds the particles to each other by surface oxide phases rather than resin, which makes it possible to prevent a decrease in the bonding strength between the particles at a high temperature, and provide a magnetic wedge with high bending strength even at a high temperature. For example, the rate of decrease in three-point bending strength when the temperature rises from room temperature (25 C) to 150° C. can be less than 5%, and more preferably less than 3%. Furthermore, the rate of decrease in three-point bending strength when the temperature rises from room temperature (25° C.) to 200° C. can be less than 10%, and more preferably less than 5%.

As described above, the conventional magnetic wedge contains resin as a binding material, so there is a problem that the resin decomposes and deteriorates when exposed to a high-temperature environment for a long period of time, causing an irreversible decrease in strength and a reduction in dimensions. In contrast thereto, such a problem does not occur in the resinless magnetic wedge of this embodiment. In this respect, a magnetic wedge with excellent heat resistance and long-term reliability can be provided. For example, the mass loss rate after 1000 hours at 180° C. can be less than 0.05%, and more preferably less than 0.03%. Further, the mass loss rate after 450 hours at 220° C. can be less than 0.1%, and more preferably less than 0.05%. Furthermore, the mass loss rate after 240 hours at 290° C. can be less than 1%, and more preferably less than 0.5%.

The heat resistance temperature of a rotating electric machine varies depending on the application and specifications, but some may be set to 155° C. or 180° C. according to standards. In addition, in some rotating electric machines, the temperature may rise to about 200° C. Since the magnetic wedge of this embodiment can maintain excellent bending strength even at a high temperature, the magnetic wedge can be suitably used in a rotating electric machine with the maximum temperature exceeding 180° C., and even in a rotating electric machine with the maximum temperature exceeding 200° C., where it was previously not possible to install a magnetic wedge.

The compacted body constituting the magnetic wedge of this embodiment is resinless and therefore has high thermal conductivity. Heat can be effectively dissipated by disposing this embodiment that has high thermal conductivity and excellent heat dissipation properties as a magnetic wedge near the gap, which is the heat source of a rotating electric machine, and it can also be expected to have the effect of improving the cooling efficiency of the rotating electric machine. Such a cooling effect is preferred as the thermal conductivity of the magnetic wedge is higher. For example, the thermal conductivity is preferably 2.0 W/(m·K) or more, more preferably 5.0 W/(m·K) or more, and even more preferably 8.0 W/(m·K) or more. Furthermore, since the thermal conductivity of the electromagnetic steel plate that constitutes a stator of a rotating electric machine is generally high at about 20 W/(m·K), it can be expected that the cooling effect is enhanced as the thermal conductivity of the magnetic wedge gets closer to this value. Therefore, the thermal conductivity of the magnetic wedge is preferably 1/10 or more, more preferably ⅕ or more, and even more preferably ⅓ or more, of the magnetic material (electromagnetic steel plate) that constitutes the stator.

In the magnetic wedge of this embodiment, at least a portion of the surface is a machined surface. The machined surface mentioned here does not mean to be limited to a surface on which machining such as cutting, grinding, and cutting off has been performed, but means a surface that has been subjected to machining. That is, it is intended to include a surface whose machined surface properties have been changed through treatment such as heat treatment or coating treatment after machining.

The machined surface is more preferably a surface that has been subjected to heat treatment to form surface oxide phases as described later. Conventionally, the magnetic wedge is pressed using a die, and therefore the surface of the magnetic wedge is a surface in contact with the die. The magnetic wedge of this embodiment can also be manufactured through pressing using a die, but the machined surface is formed on at least a portion of the surface by machining (surface machining). The surface subjected to machining has larger surface roughness than the surface that is in contact with a smooth die. For example, if the surface with large surface roughness is used as a surface that comes into contact with the teeth of a stator for a rotating electric machine, the contact resistance with the irregularities on the teeth side increases, which is expected to strengthen the fixation of the magnetic wedge. Furthermore, if the surface with large surface roughness is used as a surface on which a coating or adhesive is applied, the adhesion strength of the coating or the like can be expected to improve due to the anchor effect. The entire surface may be a machined surface, but since this complicates the machining, it is preferable to use only a necessary portion of the surface as a machined surface.

The magnetic wedge of this embodiment can be said to have a prismatic shape obtained by stretching a rectangular cross section on the xy plane in the z direction. In other words, the green compact can be said to have a prismatic shape obtained by stretching a line-symmetric figure drawn on an arbitrary plane in the normal direction of the plane. At this time, the end surface can be said to be a surface parallel to the figure drawn on an arbitrary plane. In addition, the plane surface and the side surface can be said to be a pair of surfaces obtained by stretching a pair of sides located symmetrically in the figure drawn on an arbitrary plane in the normal direction.

Further, as shown in FIG. 4, the corners of the plane may be rounded. The effect of the roundness can be obtained regardless of the compositions of the powder of the Fe-based soft magnetic particles and the binder. That is, it is preferable that the magnetic wedge of this embodiment is composed of a plurality of soft magnetic particles and has a prismatic shape obtained by stretching a line-symmetric figure drawn on an arbitrary plane in the normal direction of the plane, at least a pair of surfaces obtained by stretching at least a pair of sides located symmetrically in the line-symmetric figure in the normal direction are machined surfaces, and at least a pair of opposing sides of one or both end surfaces have rounded portions.

In the above-described first embodiment, FIG. 3 and FIG. 4 illustrate modified examples of the green compact, but in this embodiment, these may be read as modified examples of the magnetic wedge. Since the embodiment shown in FIG. 3 and FIG. 4 has already been described in detail, the description will be omitted here.

If the side surface of the green compact in FIG. 2 is a machined surface, such a surface can be used as the surface that comes into contact with the teeth in the third embodiment described later, that is, the surface where the magnetic wedge is fitted and fixed between the teeth. Such a magnetic wedge can be sandwiched by the teeth from both sides via a pair of side surfaces on which machined surfaces are formed, enabling the magnetic wedge to be fixed more firmly. The pair of side surfaces are preferably non-parallel. In this way, it is possible to firmly fix the magnetic wedge to the teeth when fitting the magnetic wedge therein, and also has the effect of improving manufacturability.

The magnetic wedge of this embodiment can also use the above-described compacted body as a base material and include an electrically insulating coating on the surface thereof. In this way, the electrical resistance and strength of the magnetic wedge can be further increased, and particles can be prevented from falling off from the surface of the compacted body, thereby providing a highly reliable magnetic wedge. For the coating, an electrically insulating coating made of resin, oxide, or the like is preferred in order to suppress eddy current loss. For example, a powder coating with epoxy resin, a sealing coating by impregnation with a varnish or silicone resin, a sealing coating of an inorganic material by a sol-gel method using metal alkoxide, and the like can be used. Among these, from the viewpoint of avoiding deterioration of the resin at high temperature, a sealing coating of an inorganic material by a sol-gel method is particularly preferred.

### (Third Embodiment) <Stator for Rotating Electric Machine and Rotating Electric Machine>

Next, a rotating electric machine 300 according to the third embodiment of the present invention will be described together with a stator for rotating electric machine, which is one of the components.

FIG. 5 is a schematic view of the rotating electric machine 300, and shows a cross-sectional structure perpendicular to the rotation axis of the rotating electric machine 300. The rotating electric machine 300 is a radial gap type rotating electric machine, and has a stator for rotating electric machine (stator 31) and a rotor (rotor 32) disposed inside the stator 31, which are arranged coaxially. The stator 31 has a plurality of teeth 34 and a plurality of slots formed by the plurality of teeth 34, and the plurality of teeth 34 around which the coils 33 are wound are disposed at equal intervals in the circumferential direction.

In the rotating electric machine of this embodiment, the magnetic wedge 100 of the second embodiment is fitted on the rotor 32 side of the slot, that is, on the rotor 32 side tip of the tooth 34 so as to connect the tips of adjacent teeth 34.

Here, the relative magnetic permeability and the saturation magnetic flux density of the teeth 34 are usually designed to be higher than those of the magnetic wedge 100. Thus, the magnetic flux from the rotor 32 that reaches the magnetic wedge 100 flows into the teeth 34 via the magnetic wedge 100, suppressing the magnetic flux reaching the coil and thereby reducing the eddy current loss that occurs in the coil.

Furthermore, when the rotating electric machine is driven, most of the magnetic flux generated in the teeth 34 by the coil current flows across the gap into the rotor 32, but a portion of the magnetic flux is attracted to the magnetic wedge 100 and spreads in the circumferential direction. This results in a smooth magnetic flux distribution in the gap between the stator 31 and the rotor 32. For example, in a rotating electric machine having a permanent magnet disposed in the rotor 32, cogging can be suppressed to further reduce the eddy current loss that occurs in the rotor 32. Additionally, for example, in an induction type rotating electric machine having a squirrel-cage conductor disposed in the rotor 32, secondary copper loss can be reduced. By disposing the above-described magnetic wedge 100 in the rotating electric machine as described above, it is possible to reduce loss and achieve a highly efficient and high-performance rotating electric machine.

The cross-sectional shape of the magnetic wedge 100 is not limited to a rectangular shape, but can be various shapes as described above. For example, as shown in FIG. 7, if the tips of the teeth 34 are shaped to have protrusions in the circumferential direction, the cross-sectional shape of the magnetic wedge 100 can be made convex and disposed as shown in the figure.

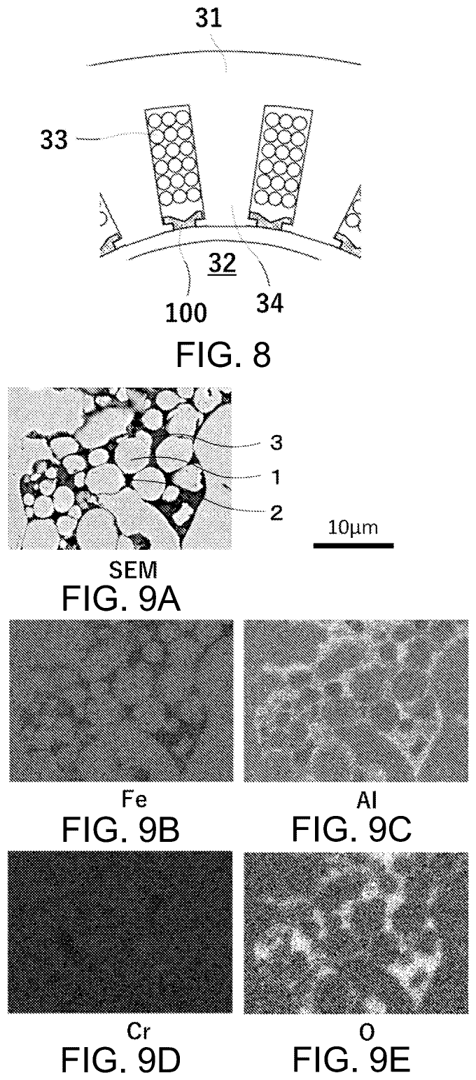

Further, it is also possible to form a shape by changing the thickness of the magnetic wedge 100 (the dimension in the radial direction of the rotating electric machine) in the width direction of the magnetic wedge. For example, as shown in FIG. 8, by forming a shape that is relatively thin near the center in the width direction, excessive short-circuiting of magnetic flux between the teeth 34 can be suppressed by the thin portion near the center of the magnetic wedge, while the thick portions at both ends can effectively smooth the spatial distribution of magnetic flux, which is preferred. This makes it possible to achieve both torque and efficiency at a high level. As other forms of the thickness of the magnetic wedge 100, various variations such as a curved or stepwise change in addition to the linear form in FIG. 8 can be applied.

In a case where the magnetic wedge 100 is disposed to connect the tips of adjacent teeth 34, it is preferable that the magnetic wedge 100 comes into contact with the teeth 34 by at least a portion of the machined surface described above. That is, it is preferable to dispose the machined surface at the portion where the magnetic wedge 100 and the teeth 34 come into contact with each other. At least a portion of the machined surface of the magnetic wedge 100 and the teeth 34 may be in direct contact, or may be in contact via an adhesive layer or the like. As described above, such a configuration can be expected to strengthen the fixation of the magnetic wedge 100.

Furthermore, by using the magnetic wedge 100 which has a prismatic shape with a line-symmetric cross section and in which a pair of side surfaces located symmetrically when viewed from the axial direction are machined surfaces, such a pair of side surfaces can be used as the surfaces that come into contact with the teeth 34, that is, the surfaces where the magnetic wedge 100 is fitted and fixed between the teeth 34. For example, the side surfaces of the teeth 34 which are formed by laminating plate-like magnetic bodies such as electromagnetic steel plates and amorphous alloy thin strips, that is, the surfaces on the slot side, have large irregularities. Therefore, by adopting the arrangement that brings such surfaces into contact with the machined surfaces of the magnetic wedge 100, it is possible to expect a stator for rotating electric machine (stator 31) and a rotating electric machine with the magnetic wedge more firmly fixed.

The thickness of the magnetic wedge 100 can be set appropriately in consideration of the relative magnetic permeability as described above, but if the magnetic wedge 100 is too thin, the strength decreases and the effect brought by the magnetic wedge 100 is also weakened, so a thickness of 1 mm or more is preferred. On the other hand, if the magnetic wedge 100 is too thick, the space of the coil 33 is compressed, which is a factor that increases copper loss, and the volume of the magnetic wedge 100 increases, so the loss (iron loss) occurring in the magnetic wedge 100 itself also increases. Therefore, the thickness is preferably 5 mm or less, more preferably 3 mm or less, and even more preferably 2 mm or less.

The width of the magnetic wedge 100 (the dimension in the circumferential direction of the rotating electric machine) is set appropriately to match the interval between adjacent teeth 34, but is preferably in the range of 2 mm to 20 mm.

The length of the magnetic wedge 100 (the dimension in the axial direction of the rotating electric machine) is basically set appropriately to match the thickness (length in the axial direction) of the stator 31, but if the magnetic wedge 100 is too long, the magnetic wedge 100 itself is difficult to manufacture and is prone to breakage when being attached to the rotating electric machine, which impairs the workability. Therefore, the length is preferably 300 mm or less, more preferably 200 mm or less, and even more preferably 100 mm or less. On the other hand, if the magnetic wedge 100 is too short, the work of attaching the magnetic wedge 100 to the rotating electric machine becomes complicated, which is undesirable. From this viewpoint, the length is preferably 10 mm or more, more preferably 25 mm or more, and even more preferably 50 mm or more.

### EXAMPLES

Examples that used an Fe—Al—Cr-based alloy as the Fe-based soft magnetic particles will be described below.

### Example 1

### (Preparation of Compacted Body (Magnetic Wedge) for Evaluating Basic Characteristics)

Alloy powder (Fe-based soft magnetic powder) of Fe-5% Al-4% Cr (% by mass) was prepared by a high-pressure water atomization method. The raw material was melted and poured under an Ar atmosphere. The average particle size (median diameter) of the prepared powder was 12 μm, the powder specific surface area was 0.4 m²/g, the true density of the powder was 7.3 Mg/m³, and the oxygen content of the powder was 0.3%.

Polyvinyl alcohol (PVA) and ion-exchanged water were added to this alloy powder to prepare a slurry, which was then spray-dried using a spray dryer to obtain granulated powder. When the raw material powder is taken as 100 parts by mass, the amount of PVA added is 0.75 parts by mass. Zinc stearate was added in a proportion of 0.4 parts by mass to the obtained granulated powder and mixed. The obtained mixed powder was filled into a die and pressed at room temperature under a pressing pressure of 0.9 GPa. The manufactured green compact was heat-treated at 750° C. for 1 hour in air. The temperature rise rate at this time was 250° C./h. The amount of oxygen contained in the compacted body after the heat treatment was 2%.

The dimensions of the samples prepared for characteristic evaluation are as follows.
Sample for evaluating bending strength and heating loss: width 2.0 mm×length 25.5 mm×thickness 1.0 mm
Sample for evaluating DC magnetization curve: 10 mm square×thickness 1.0 mm
Sample for evaluating magnetic core loss and electrical resistance: outer diameter 13.4 mm×inner diameter 7.7 mm×thickness 2.0 mm (ring shape)

### (Cross-Sectional Structure of Example)

Examples prepared as described above were subjected to cross-sectional observation using a scanning electron microscope (SEM/EDX), and the distribution of each of the components was also examined. The results are shown in FIG. 9. (a) of FIG. 9 is an SEM image, in which particles 1, voids 2, and surface oxide phases (grain boundary oxide phases) 3 can be confirmed. (b) to (e) of FIG. 9 are mapping images showing the distributions of Fe (iron), Al (aluminum), Cr (chromium), and O (oxygen), respectively. The brighter the color, the more abundant the target element. It can be seen from FIG. 9 that there is a large amount of aluminum and oxygen at the grain boundaries between the Fe-based soft magnetic particles, forming oxide phases. Furthermore, it can be seen that the soft magnetic particles are bonded to each other via the oxide phases.

### COMPARATIVE EXAMPLE

A magnetic laminate plate, which is a commercially available magnetic wedge material, was used as the Comparative Example. This magnetic wedge was made by dispersing iron powder in a glass epoxy substrate, and was cut out to the size required for various measurements from a plate material having a thickness of 3.2 mm.

### Results of Example 1 and Comparative Example

### (Density/Electrical Resistance)

The density of the sample of Example 1 above was 6.4 Mg/m³. The space factor (relative density), which is a value obtained by dividing the density of the sample by the above-mentioned true density of the powder, was 88%. On the other hand, the density of Comparative Example was 3.7 Mg/m³.

Further, the electrical resistivity of Example 1 measured using the ring-shaped sample described above was 3×10⁴ Ω·m. The electrical resistivity ρ (Ω·m) was calculated by the following formula using the resistance value R (Ω) when 50 V was applied, which was measured using a digital ultra-high resistance meter R8340 manufactured by Advantest, after forming electrodes by applying a conductive adhesive to two opposing plane surfaces of the ring sample.

$$p ( Ω \cdot m ) = R \times A / t$$

where A is the area of the plane surface of the ring sample (m²), and t is the thickness of the sample (m).

On the other hand, the electrical resistance of Comparative Example was too low to be measured by the above-mentioned ultra-high electrical resistance meter, so the electrical resistance was measured using a resistance meter RM3545 manufactured by Hioki E. E. The sample used for measurement was a plate material cut into a 10 mm square with electrodes formed on both sides. The probe of the resistance meter was pressed against the electrode to measure the electrical resistance value in the plate thickness direction, and the electrical resistivity of Comparative Example was calculated from the above formula to be 9×10⁻³ Ω·m. (DC magnetization curve)

The DC magnetization curve (B—H curve) of the sample was measured using a DC self-recording magnetic flux meter (TRF-5AH manufactured by Toei Industry) by clamping the above 10 mm square sample between the magnetic poles of an electromagnet and applying a maximum magnetic field of 500 kA/m.

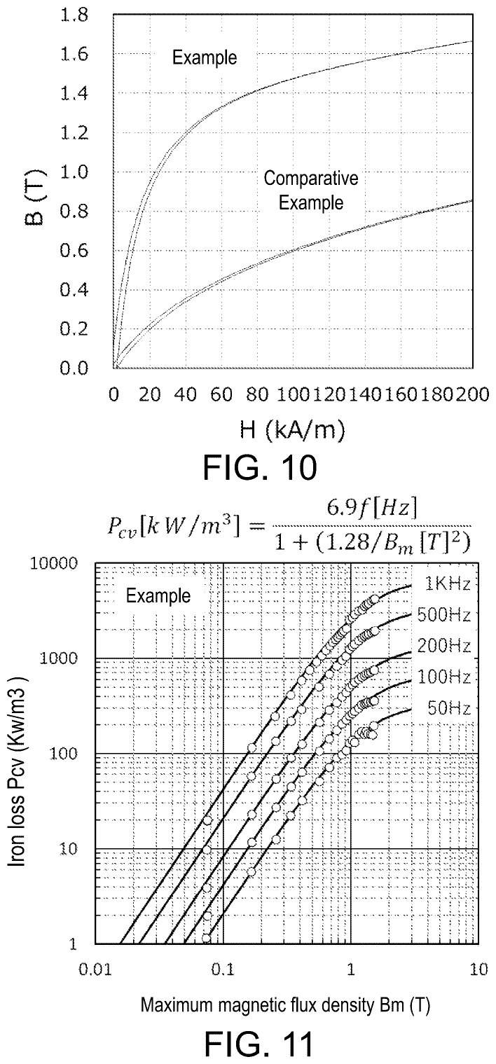

The results of measurements at room temperature are shown in FIG. 10. The figure also shows the B—H curve of Comparative Example. The magnetic flux density value in an applied magnetic field of 160 kA/m was 1.60 T for Example and 0.76 T for Comparative Example. Therefore, the relative magnetic permeability μ was 8.0 for Example and 3.8 for Comparative Example.

Further, the relative magnetic permeability μi of the sample was found to be 59 from the AC magnetization curve (minor loop) measured at f=1 kHz and Bm=0.07 T. The natural resonance frequency of Example was 150 MHz. An attempt was made to measure the magnetic core loss of Comparative Example in the same manner, but the magnetic permeability was too low, making the measurement difficult.

### (Magnetic Core Loss)

The ring sample of the above Example was provided with primary and secondary windings using polyurethane coated copper wires. The number of windings was 50 turns on both the primary and secondary sides. This sample was connected to a B—H loop analyzer (IF—BH550 manufactured by IFG) equipped with a large current bipolar power supply (BP4660 manufactured by NF Circuit Design Block) to measure the iron loss Pcv. The measurement conditions were a frequency f of 50 Hz to 1 kHz and a maximum magnetic flux density Bm of 0.05 T to 1.55 T. In order to prevent the temperature of the sample from rising due to Joule heat from the primary winding, the sample was immersed in a cooling bath (high/low temperature circulator FP50-HE manufactured by Julabo), in which the refrigerant temperature was maintained at 23° C., to measure the iron loss. Silicone oil (KF96-20cs manufactured by Shin-Etsu Chemical) was used as the refrigerant.

The results of measurements are shown in FIG. 11. The white circles in the figure indicate the measured values. As shown in the figure, in the region where Bm is high, magnetic saturation is approached and therefore Pcv shows a tendency to gradually become saturated. In the motor characteristic simulation in the next section, the measured value was used as the iron loss in Example 1. Although actual measurements were limited to Bm=1.55 T, the magnetic wedge inside the motor may be magnetized up to about 2 T, which corresponds to the saturation magnetic flux density of electromagnetic steel plates. Therefore, for the Pcv value on the high Bm side exceeding 1.55 T, the measurement results were applied to the following formula by the least squares method, and the extrapolated value of this formula was used.

$$Example 1 : Pcv = 6.9 f / ( 1 + {( 1.28 / Bm )}^{2} )$$

where the unit of Pcv is kW/m³, the unit of Bm is T, and the unit of f is Hz.

The solid lines in FIG. 11 indicate the calculated values of this formula.

The iron loss of Comparative Example was also measured in the same manner as above. The sample used for the measurement had a ring shape with an outer diameter of 20 mm, an inner diameter of 14 mm, and a thickness of 3.2 mm, and both the primary winding and the secondary winding were wound with 85 turns. Since Comparative Example had lower magnetic permeability than Example, the maximum magnetic flux density Bm that could be measured was up to 0.6 T, but the measured value was about twice the Pcv of Example. In the motor characteristic simulation in the next section, this measured value was used as the iron loss of Comparative Example. As for the Pcv value when Bm>0.6 T, the measurement results were applied to the following formula in the same manner as in Example, and the extrapolated value of this formula was used.

$$Comparative Example : Pcv = 6.7 f / ( 1 + {( 1.1 / Bm )}^{1.58} )$$

### (Rotating Electric Machine Characteristic Simulation Condition)

The characteristics (efficiency and torque) of a case where the magnetic wedge of Example 1 or Comparative Example was installed in an induction type rotating electric machine were calculated using an electromagnetic field simulation based on a finite element method. At that time, the magnetization curve in FIG. 11 and the above-mentioned iron loss value were incorporated into the calculation as the magnetic characteristics of the magnetic wedge.

The specifications of the induction type rotating electric machine used in the electromagnetic field simulation are as follows.
Stator: diameter 450 mm×height 162 mm
Number of poles: 4
Number of slots: 36
Rotor and stator material: electromagnetic steel plate (50A1000)
Rotating electric machine output: 150 KW
Rotational speed: 1425 rpm

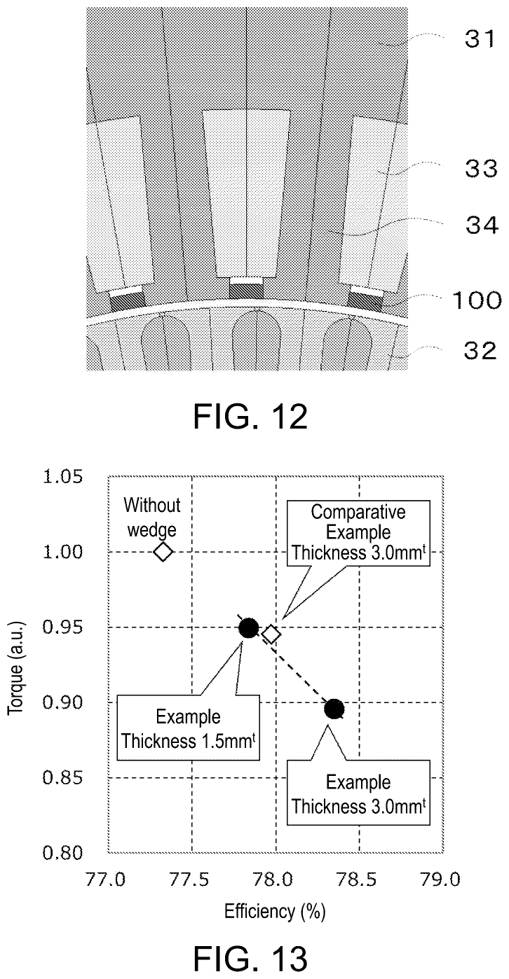

FIG. 12 shows the installation position of the magnetic wedge 100 used in this simulation. The calculation was performed with the width of the magnetic wedge (the length in the circumferential direction of the rotating electric machine) being 7.0 mm, and the thickness (the length in the radial direction of the rotating electric machine) being 0.0 mm (without magnetic wedge), 1.5 mm, and 3.0 mm.

### (Rotating Electric Machine Characteristic Simulation Result)

FIG. 13 shows the results of the electromagnetic field simulation. In this figure, the horizontal axis represents the efficiency of the rotating electric machine and the vertical axis represents the torque of the rotating electric machine, and the calculation results are plotted. The torque on the vertical axis indicates a value normalized by the torque value without the magnetic wedge. When Example 1 having a thickness of 3 mm was compared with Comparative Example, Example 1 provided high efficiency, but the torque was lower than Comparative Example. The reason is considered to be that, in Example 1 having high relative magnetic permeability, short-circuiting of magnetic flux between the teeth became more frequent than in Comparative Example. Therefore, when the thickness of Example 1 was reduced to 1.5 mm in order to suppress short-circuiting of magnetic flux, the efficiency and torque equivalent to Comparative Example were obtained.

As described above, by using Example 1 with high magnetic permeability for the magnetic wedge and reducing the thickness of the magnetic wedge, it is possible to improve efficiency while suppressing a decrease in torque. Furthermore, although not included in this electromagnetic field simulation, the space required for the coil increases as the magnetic wedge becomes thinner, and therefore it is possible to reduce the electrical resistance of the coil by increasing the coil wire diameter, which is expected to lead to further improvement in efficiency.

### (Temperature Dependence of Bending Strength)

The above-described rod-shaped sample was used to measure the three-point bending strength at temperatures from room temperature to 200° C. using a universal testing machine (Model 5969 manufactured by Instron Corporation). The measurement conditions were a load cell capacity of 500 N, a support diameter of 4 mm, an indenter diameter of 10 mm, an inter-support distance of 16 mm, and a test speed of 0.5 mm/min. The three-point bending strength σ was calculated from the load W (N) at break based on the following formula.

$$σ = 3 LW / ( 2 {bh}^{2} )$$

where L is the inter-support distance, b is the width of the sample, and h is the thickness of the sample.

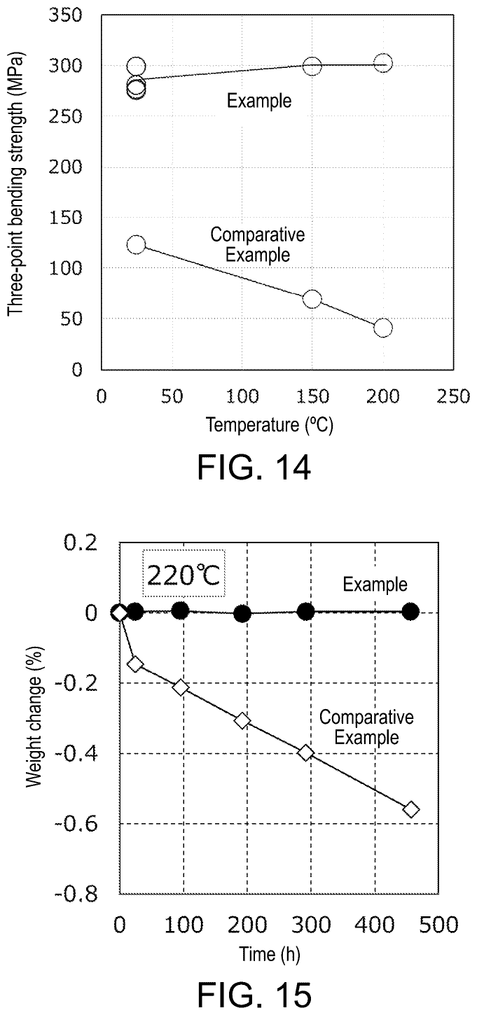

The three-point bending strength of Example obtained as described above is shown in FIG. 14. The figure also shows the three-point bending strength of Comparative Example. As shown in the figure, the three-point bending strength of Comparative Example containing resin decreases significantly with temperature rise, whereas the resinless example of this embodiment does not experience a decrease in strength even at the high temperature of 200° C., and maintains high strength equivalent to that at room temperature.

### (Heating Loss)

Since the internal temperature of a motor rises during driving, the magnetic wedge is required to be durable so as not to deteriorate in characteristics even when exposed to a high-temperature environment for a long period of time. In order to evaluate this durability, the change in mass (heating loss) due to aging was measured using the above-described rod-shaped sample. Aging was carried out in air at 220° C. and 290° C., the sample was taken out when a predetermined time passed and cooled, and the mass was measured at room temperature. The reason why the heating temperatures were set to 220° C. and 290° C. here is as follows. 220° C. is the maximum temperature that the internal temperature of the motor can reach, and 290° C. is used for an accelerated test of heating loss. For the mass measurement, an electronic balance (AUW220D manufactured by Shimadzu Corporation) with a minimum display of 0.01 mg was used. In addition, since the mass of the rod-shaped sample of Example 1 was as small as about 0.3 g, the number of samples was five in order to ensure the reliability of the measurement.

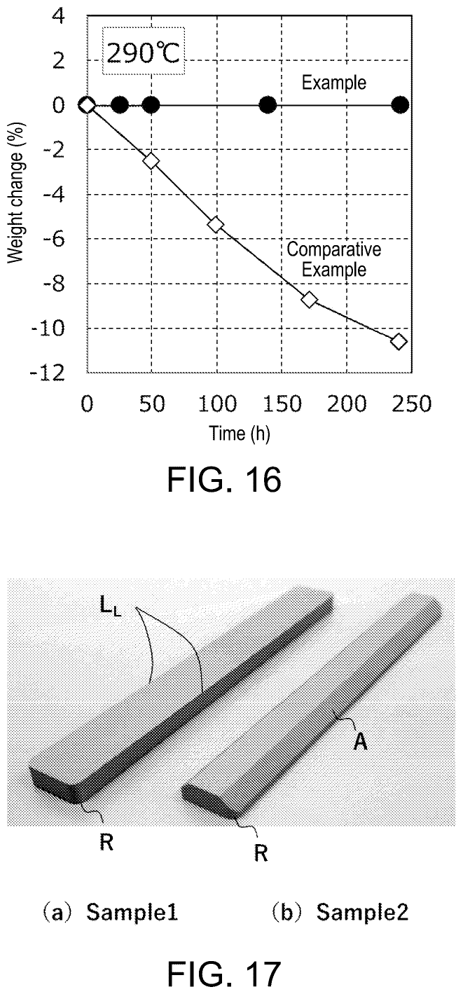

The results of measurements at 220° C. are shown in FIG. 15, and the results of measurements at 290° C. are shown in FIG. 16. In both figures, the data for Example 1 is the average value of five samples. The figure also shows the measurement results of Comparative Example. In the case of 220° C., after 456 hours, the mass of Comparative Example decreased by 0.56%, whereas the mass change of Example 1 remained at less than 0.05%. At 290° C., the difference in mass change became significant, and after 240 hours, the mass loss of Comparative Example was 10% or more, whereas the mass change of Example 1 remained at less than 0.05%. In addition, when the three-point bending strength was measured after the 290° C. aging, no change was observed in the bending strength before and after aging in Example 1, whereas the strength of Comparative Example has decreased to such an extent that the sample broke just by holding it in the hand.

As described above, the Example has excellent durability to long-term aging at high temperatures compared to Comparative Example, and can be said to be a more practical material for a magnetic wedge.

### (Thermal Diffusivity)

The thermal diffusivities at room temperature of Example 1 and Comparative Example were measured using a thermal diffusivity measuring device (LFA467 manufactured by Netzsch), and were 3.4 mm²/s for Example 1 and 0.8 mm²/s for Comparative Example. Furthermore, the specific heats at room temperature of Example 1 and Comparative Example were measured using a differential scanning calorimeter (DSC404F1 manufactured by Netzsch), and were 0.4 J/(g·K) for Example 1 and 0.5 J/(g·K) for Comparative Example. When the thermal conductivity was calculated by multiplying the thermal diffusivity, specific heat, and the above-mentioned density, the thermal conductivity was 8.7 W/(m·K) for Example 1 and 1.5 W/(m·K) for Comparative Example, with Example 1 exhibiting thermal conductivity approximately six times higher than the thermal conductivity of Comparative Example. Generally, the thermal conductivity of resin is as low as 1/10 or less of metal. Therefore, it is considered that the high thermal conductivity of Example 1 results from the characteristic of being resinless. By disposing Example 1 having high thermal conductivity and excellent heat dissipation properties as a magnetic wedge near the gap, which is the heat source, heat can be effectively dissipated, and the effect of improving the cooling efficiency of the rotating electric machine can also be expected.

### Example 2

A green compact prepared by pressing in the same manner as the green compact in Example 1 was subjected to grinding with a rotating grindstone. The machined green compact was heat-treated at 750° C. for 1 hour in air to obtain a compacted body. The sample size was 10 mm wide×80 mm long×3.5 mm thick, and the green compact was prepared by performing roundness R of 3.0 mm on a pair of opposing sides (sides in the thickness direction) L_{S} of both end surfaces in the longitudinal direction.

The surface roughness of the machined surface (the surface subjected to the above grinding) and the non-machined surface (the pressing punch surface) of the obtained compacted body was measured using a laser microscope OLS5100 manufactured by Olympus Corporation. The measurement was performed at five locations on each of the machined surface and the non-machined surface. The evaluation area per location was 1.12 mm². The arithmetic mean roughness Ra of the non-machined surface (pressing punch surface) was in the range of 2.00 μm to 3.06 μm, and the average R_{AS} was 2.37 μm. In contrast thereto, the arithmetic mean roughness Ra of the machined surface was in the range of 4.92 μm to 11.13 μm, and the average R_{MD} was 7.93 μm. From this result, it was confirmed that the ratio R_{MD}/R_{AS} of R_{MD} to R_{AS} was about 3.3, and a relatively rough surface could be formed by machining.

### Example 3

FIG. 17 shows a photograph of the appearance of a green compact sample prepared as Example 3. Pressing was performed in the same manner as in Example 1 to prepare the green compact in which the sample size was 10 mm wide×80 mm long×3.5 mm thick as in Example 2, and roundness R of 3.0 mm was performed on a pair of opposing sides (sides in the thickness direction) L_{S} of both end surfaces in the longitudinal direction. This was heat-treated at 750° C. for 1 hour in air, and the obtained compacted body was designated as Sample 1. On the other hand, a green compact was obtained by the same process as for Sample 1, and then a pair of opposing sides (sides in the longitudinal direction) L_{L} were cut so that the cross section had a modified trapezoidal shape ((d) of FIG. 3), forming non-parallel side surfaces A. The green compact was then heat-treated under the same conditions as Sample 1 to obtain a compacted body as Sample 2. In the cutting, a drill with a tip angle of 90 degrees was attached to a machining center so that the cutting edge was facing vertically downward, and the pair of sides L were cut to a chamfer dimension of 2.5 mm.

The density of the obtained compacted body was 6.19 Mg/m³ for Sample 1 and 6.23 Mg/m³ for Sample 2. Moreover, the relative magnetic permeability μ in an applied magnetic field of 160 kA/m was 6.6 for Sample 1 and 6.5 for Sample 2.

The three-point bending strength of this sample was measured at room temperature using an autograph (AGX-100kNV manufactured by Shimadzu Corporation). The measurement conditions were a load cell capacity of 100 kN, a support diameter of 20 mm, an indenter diameter of 10 mm, an inter-support distance of 50 mm, and a test speed of 0.5 mm/min. The three-point bending strength σ was calculated from the load at break, and the results were 217 MPa for Sample 1 and 229 MPa for Sample 2. When calculating the three-point bending strength σ of Sample 2, the cross-sectional secondary moment of the sample was 27.66 mm⁴ and the section modulus was 17.70 mm³.

The samples for volume resistivity measurement were cut from samples of the same shape as above, with the length changing from 80 mm to 10 mm. Electrodes were applied to the cut cross section (trapezoidal surface) using Ag paste, the sample was set in a digital ultra-high resistance meter R8340 manufactured by Advantest, and a DC voltage of 50 volts was applied to measure the electrical resistance in the 10 mm length direction. The measurement results were 5.7×10⁴ Ω·m for Sample 1 and 4.7×10⁴ Ω·m for Sample 2.

From the above result, it was confirmed that this Example in which grinding was performed had substantially no change in performance compared to a case where grinding was not performed.

As described above, according to the present invention, the particles constituting the magnetic wedge are bound to each other by the surface oxide phases, which makes it possible to provide a magnetic wedge having high electrical resistance and bending strength. Furthermore, since the magnetic wedge of the present invention is made with less resin, it is possible to provide a magnetic wedge that is excellent in heat resistance, heat dissipation properties, and long-term reliability.

Although the present invention has been described using the above embodiments, the technical scope of the present invention is not limited to the above embodiments. The content can be modified within the technical scope defined in the claims.

### REFERENCE SIGNS LIST

1: Fe-based soft magnetic particle
2: void
3: surface oxide phase (grain boundary oxide phase)
31: stator
32: rotor
33: coil
34: teeth
100: green compact (magnetic wedge)
301 to 313: side surface
304, 306, 307, 308, 310: non-parallel side surface
305, 309, 312, 313: parallel side surface
311: curved surface
R: roundness
L_{S}: side in the longitudinal direction
L_{L}: side in the thickness direction
A: machined surface

1. A method for manufacturing a magnetic wedge, comprising:
a first step of obtaining a mixture by mixing a binder and powder of Fe-based soft magnetic particles containing an element M that is more easily oxidized than Fe;
a second step of obtaining a green compact by pressing the mixture;
a third step of performing machining on the green compact; and
a fourth step of heat-treating the green compact, which has been subjected to the third step, to form surface oxide phases of the Fe-based soft magnetic particles that bind the Fe-based soft magnetic particles to each other between particles of the Fe-based soft magnetic particles.

2. The method for manufacturing the magnetic wedge according to claim 1, wherein the element M is at least one selected from a group consisting of Al, Si, Cr, Zr, and Hf.

3. The method for manufacturing the magnetic wedge according to claim 1, wherein the Fe-based soft magnetic particles are Fe—Al—Cr-based alloy particles.

4. The method for manufacturing the magnetic wedge according to claim 1, wherein the green compact has a prismatic shape obtained by stretching a line-symmetric figure drawn on an arbitrary plane in a normal direction of the plane, and
the machining is performed on a pair of surfaces obtained by stretching a pair of sides located symmetrically in the line-symmetric figure in the normal direction.

5. The method for manufacturing the magnetic wedge according to claim 4, wherein the machining is performed on the green compact to form non-parallel surfaces and increase surface roughness.

6. The method for manufacturing the magnetic wedge according to claim 4, wherein in the second step or the third step, at least a pair of opposing sides of one or both end surfaces of the green compact in a longitudinal direction are rounded.

7. A magnetic wedge, comprising:
a plurality of Fe-based soft magnetic particles,
wherein the plurality of Fe-based soft magnetic particles contain an element M that is more easily oxidized than Fe, and are bound by oxide phases containing the element M, and
at least a portion of a surface of the magnetic wedge is a machined surface.

8. The magnetic wedge according to claim 7, wherein the element M is at least one selected from a group consisting of Al, Si, Cr, Zr, and Hf.

9. The magnetic wedge according to claim 7, wherein the Fe-based soft magnetic particles are Fe—Al—Cr-based alloy particles.

10. The magnetic wedge according to claim 7, wherein the magnetic wedge has a prismatic shape obtained by stretching a line-symmetric figure drawn on an arbitrary plane in a normal direction of the plane, and
at least a pair of surfaces obtained by stretching at least a pair of sides located symmetrically in the line-symmetric figure in the normal direction are machined surfaces.

11. The magnetic wedge according to claim 10, wherein at least a pair of surfaces obtained by stretching at least a pair of sides located symmetrically in the line-symmetric figure in the normal direction are non-parallel.

12. The magnetic wedge according to claim 10, wherein at least a pair of opposing sides of one or both end surfaces in a longitudinal direction are rounded.

13. A stator for a rotating electric machine, comprising:
a plurality of teeth; and
a plurality of slots formed by the plurality of teeth,
wherein the magnetic wedge according to claim 7 is fitted between tips of adjacent teeth.

14. The stator for the rotating electric machine according to claim 13, wherein the magnetic wedge is in contact with the teeth by at least a portion of the machined surface.

15. A rotating electric machine, comprising:
the stator for the rotating electric machine according to claim 13; and
a rotor disposed inside the stator for the rotating electric machine.
